(19) United States
(12) Patent Application Publication
(10) Pub. No.: US 2002/0030350 A1
(43) Pub. Date: Mar. 14, 2002

(54) User-propelled geriatric chair

(76) Inventor: Ian Brotherston, Listowel (CA)

Correspondence Address: GOWLING LAFLEUR HENDERSON LLP, SUITE 4900, COMMERCE COURT WEST, TORONTO, ON, M5L 1J3, CA

(21) Appl. No.: 09/927,918

(22) Filed: Aug. 13, 2001

Related U.S. Application Data
(63) Continuation-in-part of application No. 09/059,866, filed on Apr. 14, 1998, now abandoned.

(51) Int. Cl. B62B 7/00

(52) U.S. Cl. 280/650; 280/87.021

(57) ABSTRACT

A wheeled chair is provided which permits patients to propel themselves with their feet while seated in the chair, and which is also capable of being used by patients of a wide range of heights. Accordingly, the present invention provides a wheeled chair having frame members, seating members, rolling means, and means to cause vertical adjustment of the seating member. In one embodiment, the seating member has means to allow it to be tilted. In this respect, the seating member is pivotally coupled to the frame members. In another aspect, such point of pivotal coupling is located proximate to the front portion of the seating member, thereby causing relatively less upward movement of the front portion of the seating member when the seating member is tilted than where such point of pivotal coupling is located rearward of the seating member. In a further embodiment, the frame members include vertically extendible arm rest members for supporting the arms of a person sitting in the chair. According to a further aspect, the arm rest members may be adjusted in co-operation with the vertical adjustment of the seating member so that the person's arms may be comfortably supported in the same vertically spaced relationship to the seating member regardless of the vertical position of the seating member relative to the floor.

### FIELD OF INVENTION

The present invention relates to a chair with wheels for use by the elderly and handicapped, and, more particularly, to a chair with wheels which permits a person sitting in the chair to move the chair by walking while in the seated position.

### BACKGROUND OF THE INVENTION

Patients in nursing homes and other long-term health care facilities are often physically challenged. Such persons require mobility aids to maintain an acceptable quality of life. Depending upon the degree of physical impairment, some patients require more assistance than others.

In this respect, various aids have been developed for the purpose of enhancing mobility. Some of these devices permit its users to physically participate in their own mobility to varying degrees By permitting such participation, reliance on caregivers is reduced. Further, participation in one's own mobility provides a feeling of independence, thereby enhancing the pafient's emotional well-being.

Some conventional wheel chair designs permit patients to propel themselves through physical upper body forces imparted to the wheels. However, people with limited upper body strength are unable to use such wheel chairs in this manner.

U.S. Pat. No. 4,893,826 discloses a chair with wheels (also known as a wheeled chair), which permits a patient to move from one location to another by “walking” while seated in the chair. This type of propulsion is also referred to herein as pedalling. Therefore, this chair enables its users to physically participate in mobility even when upper body strength and endurance are lacking.

However, the seat height of the wheeled chair disclosed in U.S. Pat. No. 4,893,826 is not capable of much adjustment. The optimum chair seat height varies depending on the height of the patient. Almost invariably, the seat height is too high, making it difficult for the patient to pedal the chair comfortably, or, in some cases, reach the ground at all. Seat heights that are too low cause excessive pressure on the patients knees, and displacement of seat pressure onto the ischial tuberosities and tail bone. Therefore, because seat height is effectively not adjustable, comfortable and safe use of the chair in U.S. Pat. No. 4,893,926 is limited to persons who fall within a relatively narrow height range.

When pedalling a chair such as that disclosed in U.S. Pat. No. 4,893,826, the patents first tendency is to lean forward excessively, causing the pelvis to be pulled forward on the seat surface, resulting in problems ranging from general uncomfortableness, poor posture, to ineffectual mobility capacity. By leaning forward in the chair, the patient also compromises his or her stability within the chair, creating a risk of falling out of the chair.

To circumvent this problem, positioning restraints are employed in the chair in U.S. Pat. No. 4,893,826. Use of such position restraints compromises emotional well-being for patients who use this chair. Further, the use of such restraints in a health care institution environment only attracts unnecessary social stigma to these if facilities. Furthermore, the use of such restraints is now almost exclusively prohibited by U.S. government regulations, and only permitted in rare circumstances.

Accordingly, there exists a real need in the art for a wheeled chair which permits patients to propel themselves with their feet while seated in the chair, and which are also capable of being used by patients of a wide range of heights.

It is also desirable for such chairs to include means to prevent patients from leaning forward excessively, without the use of positioning restraints, when patients are pedalling in these chairs.

### SUMMARY OF THE INVENTION

In order to provide a wheeled chair which permits patients to propel themselves with their feet while seated in the chair (such action hereinafter also referred to as “pedalling”), and which is also capable of being used by patients of a wide range of heights, the present invention provides, in one of its broad aspects, a wheeled chair having means to cause vertical adjustment of the seating member of such chair.

Accordingly, in one broad aspect of the wheeled chair of the present invention, such wheeled chair comprises a pair of substantially identical, parallel frame members, which are positioned in a mutually spaced apart relation with each other. Each of the frame members has an upper portion and a lower portion, as well as front and rear portions. The chair also has a vertically adjustable seating member located intermediate and coupled to the frame members with an adjustable support means for supporting the seating member. The chair also has a rolling means affixed to the frame members for allowing rolling displacement of the chair.

In one embodiment, the point of pivotal coupling of the seating member to the frame members is located proximate to the front portion of the seating member. In such configuration, the seating member may be tilted while causing relatively less upward movement of the front portion of the seating member than where such point of pivotal coupling is located rearward of the seating member. As a result, a person sitting in a chair of the present invention experiences relatively less vertical displacement of his or her knees, and is better able to maintain pedal contact with the surface on which the chair is supported while the chair is in a tilted position, thereby enabling the person to continue pedalling the chair when it is in a tilted position.

According to another aspect of the present invention, the frame members include vertically extendible arm rest members for supporting the arms of a person sitting in the chair. According to a further aspect, the arm rest members may be adjusted in co-operation with the vertical adjustment of the seating member so that the person's arms may be comfortably supported in the same vertically spaced relationship to the seating member regardless of the vertical position of the seating member relative to the frame members.

In one aspect of the present invention, the frame members define a free region of space forward of and beneath the front portions of the seating member. By having this free region of space, a person sitting in the chair is permitted to cause the chair to move by pedalling his or her feet.

In yet another aspect of the present invention, the frame members include a plurality of coupling means for coupling of the seating member to the frame members. The coupling means are in vertically spaced relationship with each other to permit vertical adjustment of the seating member relative to the frame members. In this respect, the height of the seating member relative to the floor may be adjusted to accommodate persons of different height. In particular, vertical adjustment of the seating member in correspondence with the person's height creates a seating environment where the person is able to pedal the chair comfortably, without causing excessive pressure on the person's knees, and/or displacement of seat pressure onto the ischial tuberosities and tailbone.

In a further aspect of the present invention, the rolling means comprise two pairs of rolling means. The first pair is located proximate the front portion of the frame member, and extends downwardly from and below the frame members. The second pair of rolling means is located proximate the rear portion of the frame member and extends downwardly from and below the frame members. According to a further aspect, the front pair of rolling means comprise casters, and the rear pair of rolling means comprise wheels.

### BRIEF DESCRIPTION OF THE DRAWINGS

Further advantages of the present invention will appear from the following detailed description of the invention, taken together with the following drawings in which:

FIG. 1 is a perspective view of a wheeled geriatric chair of the present invention, showing a seating member, frame members, rail members, arm rest members, rolling means, and an adjustable support means;

FIG. 2 is a second perspective view, partly cutaway, of the wheeled geriatric chair of FIG. 1;

FIG. 3 is a out-away side view of the seating member, the frame member, and the rail member of FIGS. 1 and 2, showing the manner of coupling of the seating member to the rail member;

FIG. 4 is a front view of the seating member, the frame member, and the rail member of FIG. 3, showing the manner of coupling of the seating member to the rail member in further detail;

FIG. 5 is a cut-away side view of the arm rest member and frame member of FIG. 1, showing the manner of coupling of the arm rest member to the frame member;

FIG. 6 is a front view of the arm rest member and frame member of FIG. 5, showing the manner of coupling of the arm rest member to the frame member in further detail; and

FIG. 7 is a detailed drawing of an embodiment of an extendible support member of the wheeled geriatric chair of the present invention.

### DETAILED DESCRIPTION OF THE PREFERRED EMBODIMENT

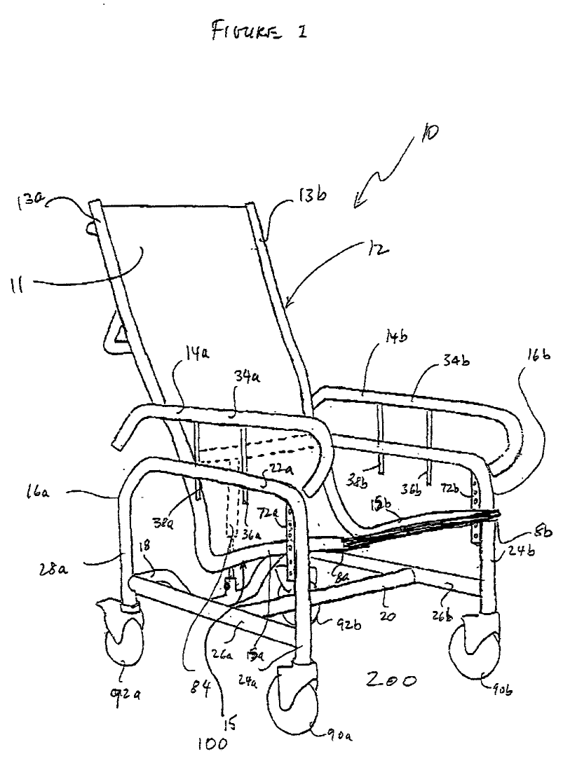

FIG. 1 shows a wheeled chair 10, adapted for rolling across a surface 100, which permits a person sitting in the chair 10 to move the chair 10, by walking while in the seated position. Chair 10 includes a seating member 12 coupled to frame 16, with rolling means 90a, 90b, 90c, 90d depending from frame 16 for contact with surface 100. Such chair is provided with means for adjusting the height of the seating member 12 and is also provided with means for tilting the seating member 12. The seating member includes support material 11 to support a person sitting in the chair 10.

As may be seen from FIG. 1, the chair 10 is constructed of a pair of substantially identical parallel left and right frame members 16a and 16b respectively, positioned in mutually spaced apart relation with each other. The left and right frame members 16a, 16b are connected together by lateral struts 18 and 20, welded at their ends. Each of the left and right frame members 16a, 16b comprises upper members 22a, 22b, front members 24a, 24b, lower members 26a, 26b, and rear members 28a, 28b, (not shown in FIG. 1) which together form quadrilateral sided frame members 16a, 16b. The left and right frame members 16a, 16b are adapted to define a free region of space 200 forward and beneath the front portion 65 of the seating member 12. The person skilled in the art will readily appreciate that these frame members may be differently shaped and contoured so long as the spatial relationship for the seating member is present.

Preferably, associated with each of the frame members 16a, 16b are arm rests 14a, 14b. Each of the arm rests 14a, 14b are coupled to the corresponding upper members 22a, 22b and are extendible.

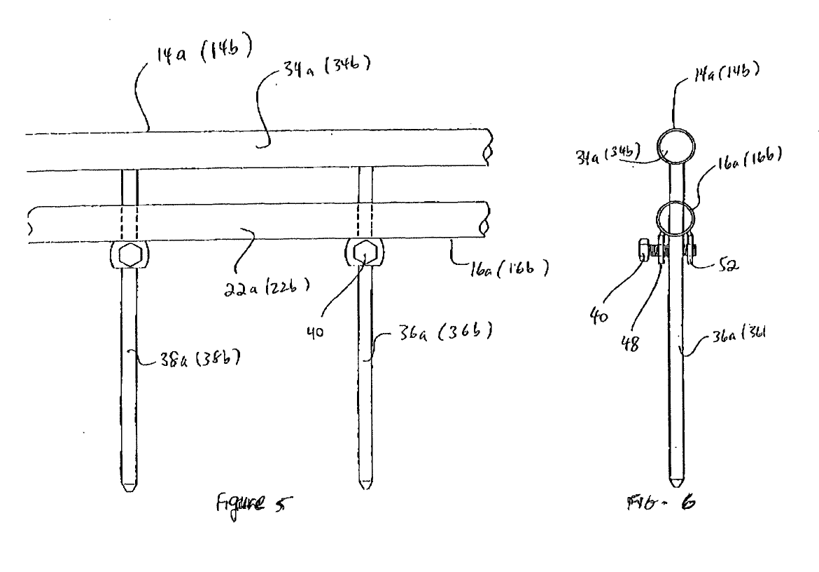

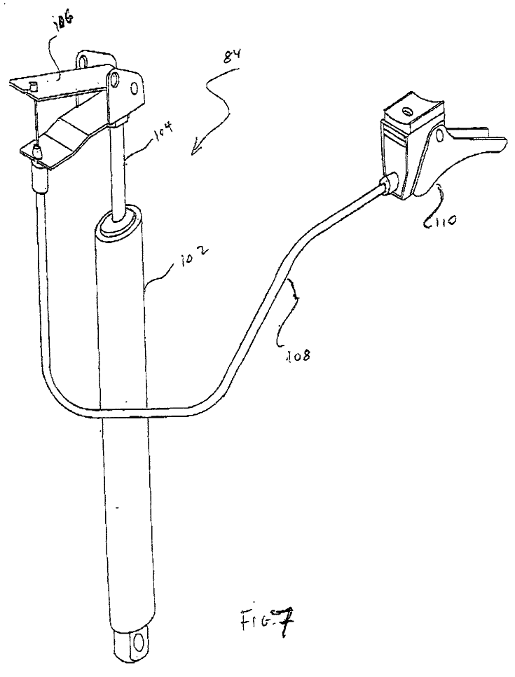

Referring to FIGS. 5 and 6, each of the upper members 22a, 22b includes a plurality of substantially vertical bores 30a, 30b, and 32a, 32b (not shown) passing through the upper member 22a, 22b and co-operatively spaced to accept insertion of the arm rests 14a, 14b. Each of the arm rests 14a, 14b is comprised of substantially horizontal arm rest members 34a, 34b, and two or more substantially vertical arm rest members (two are shown) 36a, 36b and 38a, 38b in horizontally spaced relationship with each other and corresponding with each of the bores 30a, 30b, and 32a, 32b. Each of the substantially vertical arm rest members 36a, 36b and 38a, 38b thereon are respectively fixedly coupled at an upper end thereof to, and in substantially perpendicular relationship with, the substantially horizontal arm rest member 34a, 34b. The substantially vertical arm rest members 36a, 36b and 38a, 38b are co-operatively spaced for simultaneous insertion into the bores 30a, 30b, and 32a, 32b.

Each of the arm rest members 36a, 36b and 38a, 38b has an associated securing means for securing the arm rest members 36a, 36b and 38a, 38b to the frame members 16a, 16b, preferably a friction locking mechanism. Referring particularly to FIG. 6, such a locking mechanism includes a bolt 40, inserted through a bore 44 (not shown) in a plate element 48 integral with the corresponding frame member 16a or 16b, which urges the arm rest members 36a, 38b and 38a, 38b against a set screw 52 which is also integral with the corresponding frame member 16a or 16b. Other means for locking the arm rest members such as spring loaded pins or the like can be readily appreciated by those skilled in the art.

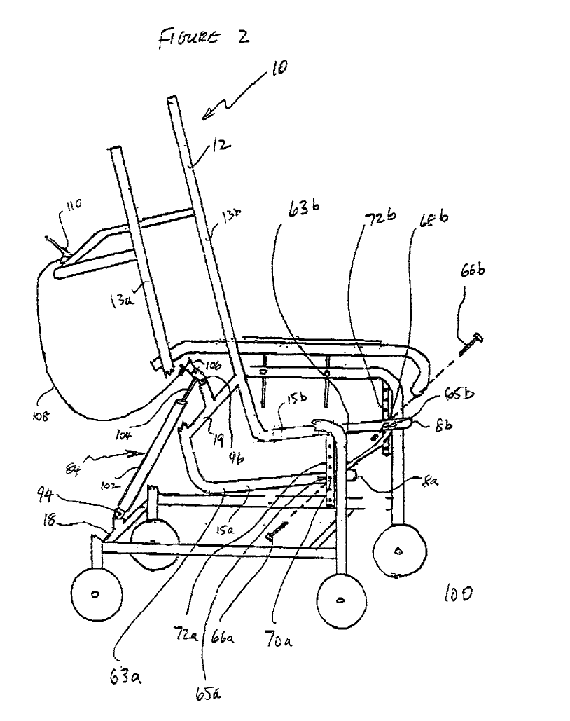

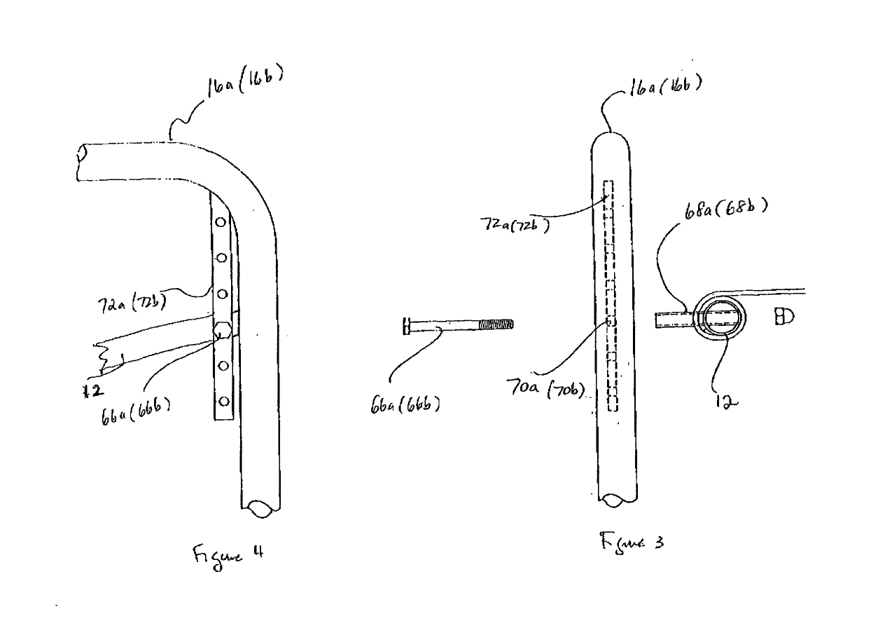

Referring to FIG. 1, the seating member 12 comprises a seat 15 and an integral backrest 13 Seat 15 includes seat frame members 15a, 15b. Backrest 13 includes backrest frame members 13a, 13b. Seat frame members 15a, 15b merge with backrest frame members 13a, 13b respectively, Each side 63a, 63b of the seat frame members 5a, 15b has an associated coupling means for coupling the sides of the seat frame members 15a, 15b to the frame members 16a, 16b, in pivotal manner. Referring to FIGS. 2, 3, and 4, seating member 12 is pivotally coupled to each of frame members 16a, 16b at locations 65a, 65b proximate the front edges 8a, 8b of seat frame members 15a, 15b. In this respect, the seating member 12 is coupled to each of the frame members 16a, 16b by bolts 66a, 66b inserted through caxial bores 68a, 68b and 70a, 70b in seat frame members 15a, 15b and the frame members 16a or 16b, respectively. The pivot connections at points 65a, 65b are made along the sides 63a, 63b of the seat frame members 15a, 15b.

Referring to FIGS. 1, 2, 3, and 4, a plurality of coupling means are provided in vertically spaced relationship with each other to permit vertical adjustment of the seating member 12 relative to the frame members 16a, 16b. Such coupling means are comprised of rail members 72a, 72b associated with each of the front members 24a, 24b, each rail member 72a, 72b having a plurality of bores in vertically spaced relationship with each other (five are shown). The vertical height of the seating member 12 relative to the surface 100 upon which the chair is supported may be adjusted by loosening and removing the bolts 66a, 66b, repositioning the seating member 12 relative to the floor, and then re-securing the seating member 12 to each of the frame members 16a, 16b by passing the associated bolts 66a, 66b through a different bore.

Adjustable support means, in the form of an extendable support member 84, is provided to further support the chair 10. As shown in FIG. 1, the extendable support member 84 is a gas spring or piston containing a compressible gas. A suitable gas spring is a BLOC-O-LIFT™ spring locking gas spring using a Bowden cable system, and as manufactured by Stabilus GmbH. A detailed drawing of this embodiment of the extendible support member 84 is provided in FIG. 7. The gas spring is a closed system consisting of a pressure tube 102 and a hollow piston rod 104 extending from the pressure tube 102. Piston rod 102 terminates in a piston within pressure tube 102. A compressed gas is provided within tube 102. The pressure tube 102 is separated into first and second chambers by a valve (not shown). The valve is actuated by a release pin which extends from the valve and through the piston rod 104, and extends externally of the piston rod 104 for actuation by release plate 106. When the valve is open in response to depression of the release pin, the piston rod will be extended in a controlled, dampered manner at the defined gas spring force. The piston rod can further be compressed by application of an external force to overcome the gas spring force when the valve is open. As soon as the actuator pin is released from the outside, the valve will close automatically because of the gas pressure exerted on it. The piston or piston rod is then locked, as gas exchange between the chambers is interrupted. The cylinders may thus be releasably locked in a desired position when the chair seat 12 or backrest 16 is tilted to a desired position. In one embodiment, such valve is manually controlled by a wire 108 and an associated manual lever 110, which thereby controls locking of the cylinder. Alternatively, such an extendible support member can be lockable helical springs or a ratchet mechanism.

The extendable support member 84, when locked, exerts an upward force on the chair 10 to thereby resist the downward weight of a person sitting in the chair 10.

The extendable support member 84, is pivotally coupled at one end to the lateral strut 18 of frame 16, at a pivot point 94, and coupled at an opposite end thereto to a strut 19 extending between back rest frame members 13a, 13b of seating member 12, at a pivot point 96.

Referring to FIG. 1, front casters 90a, 90b and rear wheels 92a, 92b are provided to allow a patient, who is sitting in such chair 10, to propel him or herself by “pedalling” his or her feet.

Although the disclosure describes and illustrates preferred embodiments of the invention, it is to be understood that the invention is not limited to these particular embodiments. Many variations and modifications will now occur to those skilled in the art.

We claim:

1. A wheeled health care chair comprising:
first and second substantially parallel frame members, positioned in mutually spaced apart relation with each other, each of the frame members having wheels depending therefrom for contacting a reaction surface;
a vertically positionable seating member located intermediate the first and second frame members, the seating member having a rear portion, a front portion, and first and second lateral sides with respective first and second front segments, the first lateral side releasably coupled to the first frame member with a first single coupling member at the first front segment for supporting the first lateral side, and the second lateral side releasably coupled to the second frame member by a second single coupling member at the second front segment for supporting the second lateral side; and
an extendible support member for supporting the rear portion of the seating member.

2. The wheeled health care chair as claimed in claim 1 wherein the first and second coupling members are bolts received in co-operating apertures in each of the first and second frame members and in each of the first and second lateral sides.

3. The wheeled health care chair as claimed in claim 2 wherein the first and second lateral sides of the seating member include respective first and second front edges, and wherein the first lateral side is pivotally coupled to the first frame member proximate the first front edge and the second lateral side is pivotally coupled to the second frame member proximate the second front edge, such that the seating member is tiltable.

4. The wheeled health care chair as claimed in claim 3 wherein said seating member is pivotable below a horizontal plane passing through the pivot point.

6. The wheeled health care chair as claimed in claim 4 further comprising an adjustable support member having first and second ends, wherein the seating member includes a back rest and the adjustable support member is coupled at its first end to the back rest for providing support thereof.

7. The wheeled health care chair as claimed in claim 5 further comprising a strut joining the first and second frame members, wherein the adjustable support member is coupled at its second end to the strut.

8. The wheeled health care chair as claimed in claim 6 wherein the adjustable support member is a gas piston.

9. The wheeled health care chair as claimed in claim 7 further comprising:
an arm rest associated with either of the first and second frame members, the arm rest having an arm support member and an elongated attachment member descending from the arm support member in substantially perpendicular relation thereto, and
first and second releasable securing members for contacting and pressing against opposing sides of the attachment member, thereby pinching the arm rest between the first and second securing members and securing the arm rest in a desired position relative to the associated frame member.

10. The wheeled health care chair as claimed in claim 8 wherein each of the frame members has an upper portion having a substantially vertical throughbore extending therethrough, each of the upper portions having a first lateral side and a second lateral side, and wherein the elongated attachment member is received by the throughbore of the corresponding frame member for travel therethrough.

11. The wheeled health care chair as claimed in claim 9 further comprising first and second alignment plates depending from the first and second lateral sides respectively, the first and second alignment plates associated with the first and second securing members respectively, each of the alignment plates having throughbores for receiving travel of the securing members.

12. A wheeled health care chair comprising:
first and second substantially parallel frame members, positioned in mutually spaced apart relation with each other, each of the frame members having wheels depending therefrom for contacting a reaction surface;
a back rest; and
a tiltable seating member located intermediate the first and second frame members, the seating member having a rear portion and first and second lateral sides with respective first and second front edges, wherein the seating member is pivotable about an axis proximate the front edge.

13. The wheeled health care chair as claimed in claim 10 wherein the first lateral side is pivotally coupled to the first frame member proximate the first front edge, and the second lateral side is pivotally coupled to the second frame member proximate the second front edge.

14. The wheeled health care chair as claimed in claim 11 wherein the seating member is pivotable below a horizontal plane passing through the pivot point.

15. The wheeled health care chair as claimed in claim 12 further comprising an adjustable support member having first and second ends, wherein the adjustable support member is coupled at its first end to the back rest for providing support thereof.

16. The wheeled health care chair as claimed in claim 13 further comprising a strut joining the first and second frame members, wherein the adjustable support member is coupled at its second end to the strut.

17. The wheeled health care chair as claimed in claim 14 wherein the adjustable support member is a gas piston.

18. A wheeled health care chair comprising:
first and second substantially parallel frame members, positioned in mutually spaced apart relation with each other, each of the frame members having wheels depending therefrom for contacting a reaction surface;
a tiltable seating member located intermediate and coupled to each of the first and second frame members;
an arm rest associated with either of the first and second frame members, the arm rest having an arm support member and an elongated attachment member descending from the arm support member in substantially perpendicular relation thereto; and
first and second releasable securing members for contacting and pressing against opposing sides of the attachment member, thereby pinching the arm rest between the first and second securing members and securing the arm rest in a desired position relative to the frame member.

19. The wheeled health care chair as claimed in claim 18 wherein each of the frame members has a substantially horizontal upper member having a substantially vertical throughbore extending therethrough, each of the upper members having a first lateral side and a second lateral side, and wherein the elongated attachment member is received by the throughbore of the corresponding upper member for travel therethrough.

20. The wheeled health care chair as claimed in claim 19 further comprising first and second alignment plates depending from the first and second lateral sides respectively, the first and second alignment plates associated with the first and second securing members respectively, each of the alignment plates having throughbores for receiving travel of the securing members.

21. The wheeled health care chair as claimed in claim 20 wherein the first and second alignment plates are in threaded engagement with the first and second securing members respectively.
